(19) United States
(12) Patent Application Publication
(10) Pub. No.: US 2005/0071189 A1
(43) Pub. Date: Mar. 31, 2005

(54) System, method, and business method for storage, search and retrieval of clinical information

(76) Inventors: Richard A. Blake, Lakeside, CA (US); Stephen W. Kenney, San Diego, CA (US); Christopher W. McKewon, San Diego, CA (US); William D. O'Riordan, La Jolla, CA (US)

Correspondence Address: Terrance A. Meador, Esq.;INCAPLAW, 1050 Rosecrans Street, Suite K, San Diego, CA, 92106, US

(21) Appl. No.: 10/670,763

(22) Filed: Sep. 25, 2003

(51) Int. Cl. G06F 17/60; G06F 7/00; G06F 17/30

(52) U.S. Cl. 705/2; 707/3

(57) ABSTRACT

Patient medical information is processed for storage and retrieval subject to anonymity constraints. The patient medical information is divided into a first information portion including information identifying a patient and information identifying a physician of the patient, and a second information portion including clinical and demographic information for the patient and the information identifying the physician. A unique code associated with the patient, but which does not identify the patient, is obtained when the first and second information portions are processed. The unique code is appended to the first and second information portions. The first information portion is then stored in a first information storage facility with other first information portions for other patients, and the second information portion is stored in a second information storage facility, separate from the first information storage facility, with second information portions for other patients. The anonymity constraints include the ability to mine the second information storage facility for clinical and demographic information useful for evaluating protocols for clinical trials and assembling candidate groups for the clinical trials without revealing the identities of the patients. Search results are made available to physicians who are identified in the results. Those physicians may then recruit their patients for participation in clinical trials.

### BACKGROUND OF THE INVENTION

The invention concerns the processing of patient medical information for storage. More particularly, the invention concerns the processing of such information subject to anonymity constraints, and the storage, search and retrieval of such information subject to those anonymity constraints.

The invention additionally concerns a business method in which protocols for clinical trials are evaluated and candidates for clinical trials are recruited using clinical and demographic information for a large, diverse patient population that is provided from a database system containing patient medical information subject to anonymity constraints. The business method further concerns placing codes in the patient information denoting a patient, without identifying the patient, and at least one physician having a physician/patient relationship with the patient in order to facilitate and motivate patient recruitment by physicians.

Before new drugs and medical devices can be released for clinical use, they must be evaluated in clinical trials. A clinical trial is a controlled test of a new drug or medical device conducted on a selected group of people according to a protocol (a test plan). Before a clinical trial can be conducted, the protocol must be written and evaluated for efficacy and reliability. A poor trial protocol will produce unreliable trial results. One way to increase the quality of a protocol is to evaluate its assumptions with reference to clinical and demographic information for a large, diverse population of patients. Once the protocol is established and evaluated, a group of clinical trial participants must be recruited. Again, the trial results will be enhanced by a trial group drawn from a large, diverse patient population. Having clinical and demographic information for a large, diverse patient population would enable a trial investigator to efficiently and effectively harvest and recruit potential trial candidates from the population.

A recent publication (“Patient Recruitment: The growing challenge for pharmaceutical companies”, IBM Global Industries, June 2002) details the difficulty of assembling patient groups for clinical trials. Patients meeting appropriate criteria must be found and then recruited for participation in a trial. Patient populations for trials are typically accessed through investigators hired to conduct trials. Advertising is frequently used to motivate potential patients. However, the limited number of investigators imposes a bottleneck on the process. Consequently, a potential pool of candidates for any clinical trial takes a significant amount of time and a substantial investment of money to assemble.

Some of the solutions to increasing candidate pools include conducting trials in lesser-developed nations and direct on-line recruiting. These solutions are limited in effectiveness. Because of a variety of factors, the populations in lesser-developed countries tend to be genetically-uniform. And so the results produced by such a population in the test of a pharmaceutical might differ from those produced by the pharmaceutical in a larger, more genetically diverse population. Direct recruiting of patient populations through the mail or by electronic means is a slow, expensive, multi-step process that produces incomplete and frequently inaccurate information about potential participants.

There is clearly a need to increase the pool size and the success rate of patient recruitment for clinical trials, but the methods employed to date have clearly reached a limit in effectiveness. One largely untapped source of candidates is the compound population of people who have doctor/patient relationships with physicians who do not conduct clinical trials. This population is large, diverse, and well documented. Its members have close trusting relationships with physicians; their patient records include demographic, medical, and increasingly, genetic information that can be mined to evaluate trial protocols and to recruit and assemble appropriate trial groups. There are three problems with gaining access to this group's medical information. First, physicians may feel inhibited from acting on or using the information outside or in contravention of the doctor/patient relationship. Second, patient information is subject to personal, cultural, and, increasingly, legal constraints based on privacy. Finally, without mitigation of these and other factors, physicians are not motivated to participate in recruitment of their own patients for clinical trials.

### SUMMARY OF THE INVENTION

The invention provides an effective solution to the problem of access to clinical and demographic information for large patient populations in the face of constraints due to the relationship between patient and doctor and requirements to preserve patient privacy. According to the invention, patient medical information is processed to enforce anonymity constraints which permit storage of the information for evaluation of protocols for clinical trials and efficient harvesting of potential candidates for clinical trials without disclosing patient identities. Clinical and demographic information relevant to a trial protocol can be obtained for a demographically and medically relevant group of patients by a third party subscriber without the patients' identities being revealed. Only a physician for a patient who is a potential candidate for a clinical trial can access an information record including the patient's identity, and recruit the patient for a trial.

Patient medical information useful for testing protocols for clinical trails and for recruiting trial participants is processed for storage by separating first information identifying a patient from second information including clinical and demographic information specific to the patient. The patient medical information has a source, usually a medical provider such as a physician, or medical institution, although non-medical providers may also be sources of patient medical information. A unique, randomly generated identifier is obtained for the patient. The patient's identity cannot be ascertained with reference to the unique identifier. The invention presumes at least one physician treating the patient. A first information portion with the information identifying the patient, the unique identifier, and a physician identifier is stored in first information storage. A second information portion with the unique identifier, the physician identifier, a source identifier, and the demographic, medical, and genetic information is stored in a second information storage which is separate from, and possibly separately administered than, the first information storage. The anonymity constraints include the separation of information identifying the patient from the patient's clinical and demographic information, and the barring of any user, save a physician, from access to patient identities in the first information storage. Such constraints permit the contents of the second information storage to be accessed and searched according to clinical trial protocols by a limited set of users outside of a doctor/patient relationship without reveling patient identities. Preferably, the limited set of users includes at least third party subscribers permitted to conduct limited searches using queries based on trial protocols, and administrators permitted to harvest candidates by providing their physicians with lists of the second information portions satisfying clinical trial protocols. Processing which is under a physician's control can determine the identities of the physician's patients in the list by use of the unique identifiers in the list. Those patients can then be recruited by the physician within the bounds of the doctor/patient relationship and without reveling patient identities outside of that relationship without patient consent.

The business objective of accumulating clinical and demographic information for a large, diverse patient population that is useful for evaluating trial protocols and motivating and involving physicians in the recruitment of their patients is achieved by implementation of the anonymity constraints, which shield patients' identities from third parties, and by provision of the physician identification with first and second information portions.

### BRIEF DESCRIPTION OF THE DRAWINGS

FIG. 1 is a block diagram showing the architecture of a system according to the invention;

FIG.2 is a diagram showing the functional flow during the operation of the system of FIG. 1.

FIG. 3 is a data structure map showing an information data structure relevant to patient clinical and demographic information in an information storage facility.

FIG. 4 is a privilege table with entries establishing access privileges to the patient clinical and demographic information represented in the data structure map of FIG. 3.

FIG. 5 is a flow diagram illustrating third party access to the patient clinical and demographic information represented in the data structure map of FIG. 3.

FIG. 6 is a flow diagram illustrating administrator access to the patient clinical and demographic information represented in the data structure map of FIG. 3.

FIG. 7 is a flow diagram illustrating physician access to the patient clinical and demographic information represented in the data structure map of FIG. 3.

### DETAILED DESCRIPTION OF THE PREFERRED EMBODIMENTS

The invention may be described herein in terms of functional block components, various processors, various processes and various processing steps. It should be appreciated that such functional blocks may be realized by any number of hardware and/or software components configured to perform the specified functions. For example, various hardware aspects of the invention may employ integrated circuit components, e.g., memory elements, digital signal processing elements, logic elements, look-up tables, and the like, which may carry out a variety of functions under the control of one or more programmed general purpose digital processors or other control devices. Further, various processes and other processing or algorithmic aspects of the invention may involve software programs, routines, or applications executed or capable of being executed by programmed general purpose or customized digital processors, or other programs.

The particular implementations of the invention which are shown and described herein are illustrative of the invention and its best mode and are not intended to otherwise limit the scope of the invention in any way. Furthermore, the connecting lines shown in the various figures contained herein are intended to represent exemplary functional relationships and/or couplings between various elements for communication and cooperative processing. Those skilled in the art will appreciate that such couplings may be point-to-point, and/or by way of local or wide-area networks, or both. It should be noted that many alternative or additional functional relationships or inter-element connections may be present in a practical embodiment.

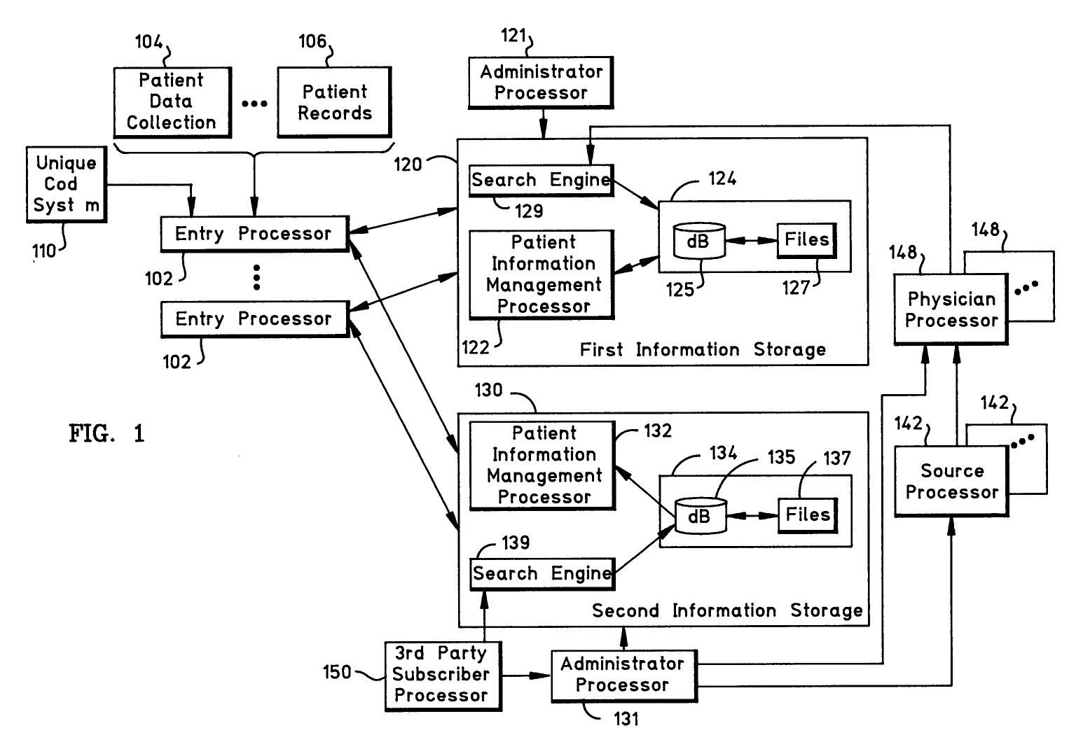

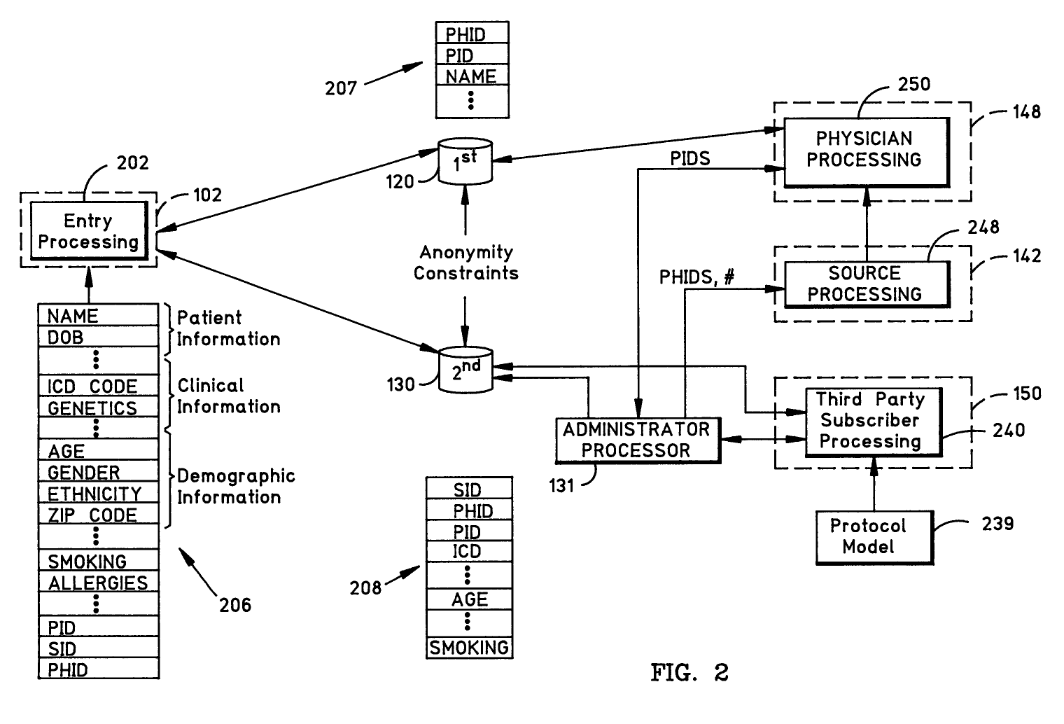

FIG. 1 is a schematic diagram of a system 100 configured in accordance with the present invention for storage, search and retrieval of patient medical information, including clinical and demographic information, and FIG. 2 is a process flow diagram illustrative of data processing associated with the operation of the system 100 according to the invention.

The invention concerns the processing of “patient medical information” including “clinical information”. In this regard, clinical information is information regarding the nature, scope, status, progress of a human disease, abnormality, or defect, and equivalents. Patient medical information is clinical information specific to a patient, with the addition of patient identification, demographic information, treatment information, and so on.

The invention also concerns a “physician” or physicians who have physician/patient relationships with patients. The factors of responsibility and confidentiality that traditionally characterize such relationships may also be accorded, with patient permission, or by law or custom, to those who are, strictly speaking, not physicians. Nevertheless, for purposes of this specification, all persons or institutions who at least have standing or permission to access medical information containing patients' identities and to recruit such patients are considered to be within the meaning of the term “physician”.

According to the invention, the system 100 and certain methods of its operations are utilized to process and store patient medical information under anonymity constraints. The anonymity constraints include separation of patient medical information into a first portion that includes patient identification information and a second portion that includes clinical and demographic information but no patient identification information. A unique code specific to the patient, but from which the patient's identity cannot be derived, is obtained and appended to the first and second portions. The first and second portions, with the appended code, are stored in functionally and administratively separate first and second information storage facilities. As second information portions accumulate in the second information storage facility, a database of clinical and demographic information derived from a multitude of patient experiences grows. The clinical and demographic information that this database contains can be searched or mined for use in evaluating clinical trial protocols and harvesting potential candidates for clinical trials. However, because the second information portions are shorn of patient identification information, the anonymity of the patients whose medical information is in the second information storage facility is preserved.

Patient medical information is accumulated and recorded by physicians, health practitioners, and personnel in the field, physicians' offices, medical groups, hospitals, HMOs, emergency rooms, acute care facilities, and the like. Medical records are typical, but not the only examples of documents with patient medical information. Patient medical information may also be accumulated and recorded by non-medical persons and institutions, such as insurance companies, government bureaus, and the like. Patient medical information is usually subject to the physician/patient privilege or to some other confidentiality privilege, and to privacy constraints, which include legal schemes to protect patient privacy.

The usual custodians of patient medical information, at least that patient medical information that is contained in medical records, include the patient's physicians, clinics, hospitals, HMOs, and other equivalent persons and organizations. The other, non-medical, custodians of patient medical information include those identified above any other equivalent persons and organizations. The invention contemplates that these custodians will be authorized to provide patient medical information. Any such custodian that provides patient medical information for the uses of this invention will be referred to as a “source”.

In FIG. 1 the system 100 includes at least one entry processor 102 which processes patient medical information made available by one or more sources for entry into the system 100. Such information may reside in printed or electronic form in, for example, patient records 106, and one or more patient data collections, such as the collection 104. The entry processor has access to a system, device, procedure, or other equivalent means (hereinafter “system 110”) for generating or providing a unique code for each patient whose medical information is processed for entry into the system 100. The unique code is a digital number that is associated with the patient and which, for the system 100, distinguishes the patient from all other patients for whom other unique codes are generated. The digital code however does not “identify” the patient in the sense that the code itself is discernibly the patient's name, address, social security number, telephone number, or other equivalent information, although the code may be generated using such information. The code is, preferably, a nine-digit, pseudo-randomly generated number. Other means of obtaining or generating the code include steganography, encryption, and the like, are contemplated.

The entry processor is coupled, or connected for communication and co-operative processing with at least two separate information storage facilities 120 and 130. The facilities 120 and 130 are similarly configured and perform similar operations, but are functionally separate, and subject to separate administration. In this regard, the first information storage facility is subject to the administration of system administrator process 121, while the second information storage facility is subject to the administration of system administrator process 131. The administrators of the facilities 120 and 130 are, preferably, separate organizations, although they may be walled-off components of the same organization. The first information storage facility 120 includes a patient information management processor 122 that operates an information storage 124, which may include, for example, a database system 125 and an associated file system 127. A search engine 129 (or a search engine interface) is included in the first information storage facility 120 for searching, or supporting searching of the first information storage facility 120. The second information storage facility 130 includes a patient information management processor 132 that operates an information storage 134, which may include, for example, a database system 135 and an associated file system 137. A search engine 139 (or a search engine interface) is included in the second information storage facility 130 for searching, or supporting searching of the second information storage facility 130. At least one source processor 140 is coupled, or connected for communication and co-operative processing with the administrator process 131. Each source processor is associated with one and only one source identified in the information stored in the facilities 120 and 130, although each such source may have more than one source processor associated with it. At least one physician processor 148 is coupled, or connected for communication and co-operative processing with one or more source processors 142, and with the administrator processor 131. In addition the at least one physician processor is connected or coupled to the search engine 129 of the first information storage facility 120. Each physician processor is associated with one and only one physician identified in the information stored in the facilities 120 and 130, although each such physician may have more than one physician processor associated with it. At least one third party subscriber processor 150 is connected or coupled to the search engine 139 of the second information storage facility 130 and to the administrator processor 131.

Refer now to FIG. 2 for an understanding of processing conducted according to the invention. The explanation is with reference to the system of FIG. 1, although the methods embodied in the processing may be performed on other system architectures without departing from the spirit or scope of the invention. In FIG. 2, entry processing 202 is performed by way of an entry processor 102. Entry processing 202 operates on patient medical information, parsing and formatting such information into digital data structures appropriate for the uses and functions to be described. For example, patient medical information may be represented by the information structure 206. The information structure 206 includes patient identity information, including a patient's name, date of birth (DOB), address, social security number, and so on. The information structure also includes clinical information respecting morbidity and mortality factors describing the patient's health. One useful piece of clinical information in this regard is a diagnosis of the patient's condition in the form of an ICD (International classification of Disease) code. Genetic information of the patient may also be included in the clinical information. Clinical information may also include behavioral information such as whether or not the patient smokes, drinks, exercises, and so on. The information structure also includes demographic information respecting the patient's positioning the human continuum. At the least, this information includes the patient's age, gender, ethnicity, location (zip code, for example) and, perhaps, religion. Other, more detailed, demographic information might also be included.

Entry processing 202 also includes obtaining a number of codes used to manage and administer the storage and retrieval of patient medical information. In this regard, the unique code for a patient has already been described. Hereinafter the unique code is referred to as a PID. A second code, SID, is provided to identify the source of the patient medical information. A third code, PHID, is provided to denote at least one physician having a doctor/patient relationship with the patient.

The entry processing 202 separates the patient medical information for a patient into at least two portions. A first information portion 207 includes the patient identification information, the PHID, and the PID. The first information portion 207 is formatted for storage in the first information storage facility 120, preferably as a multi-field database record. A second information portion 208 includes the patient's clinical and demographic information, the SID, the PHID, and the PID. The second information portion 208 is formatted for storage in the second information storage facility 130, preferably as a multi-field database record.

One may now appreciate the anonymity constraints by which important and useful clinical and demographic information is accumulated in the second information storage facility 130 on a per patient basis, preferably on a record-by-record basis, unassociated with any patient's identity. This makes the information available for searching or mining on a multilevel access basis using criteria for clinical trial protocols, without divulgation of patient identity. Anonymity is reinforced and advanced by provision of separate administrators for the facilities, and by a scheme of multilevel privilege for access to the information. The objective of such separation is to prevent or deter the discovery or ascertainment of any patient's identity by other than a physician of the patient, and synthesis of an entire patient medical information for any patient.

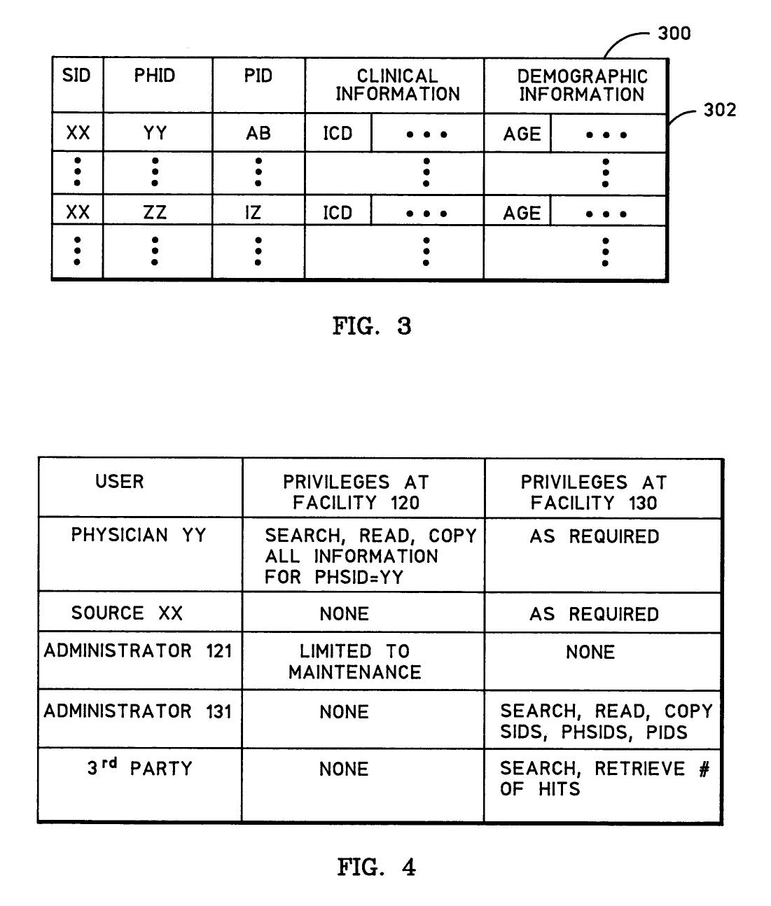

According to the invention and with reference now to FIG. 3 and FIG. 4, it will be appreciated that the anonymity constraints are advanced by a scheme of access privilege which establishes varying levels of read only access to the second information structures in the second information storage facility 130. In this regard, FIG. 3 illustrates a consolidated or abstract data base table structure 300 that represents the clinical and demographic information stored in the facility 130. Those skilled in the art will appreciate that this table structure 300 is merely illustrative and not limiting with respect to how data tables and records may be formatted and stored and how clinical and demographic data may be stored and accessed in the facility 130. Thus, the topmost row 302 in the table includes or points to the SID of source XX, and the PHID of physician YY, the PID of a patient AB of physician YY, and the clinical and demographic information of the patient AB. Manifestly, the table structure provides an information structure that can be searched or mined in a straightforward fashion. For example a query to the table structure may be FIND THE NUMBER OF RECORDS THAT INCLUDE ICD CODE ZZZZ AND MALES BETWEEN THE AGES OF 45 AND 60. In FIG. 4, prior to executing the query, the identification of the user submitting the query is found in a privilege table that establishes what privileges various classes of users have. For example, if the user is a third party subscriber, the privilege table would accord the subscriber the privilege of viewing a number representing the total number of patient second information structures in the second information storage facility 130 that satisfy the criteria.

With further reference to FIGS. 1-4, a physician processor associated with physician YY has privileges at the facility 120 to search patient identities only for patients of the physician YY. The physician processor has no privilege to access the information in the second facility 130. A source processor associated with source XX has no privilege to access information in the storage facility 120. Preferably, a source processor will have no access privilege at the second facility 130, although some control scenarios may accord a limited source processor privilege for access to information in the second facility 130. The administrator processor 121 has access to the information in the first facility only at a level sufficient to ensure proper operation of the facility, but under no circumstances does the processor 121 have access to patient identities in the first facility. The administrator processor has no access privileges to the second information storage facility 130. The administrator processor 131 has the highest level of privilege in accessing the information in the second information storage facility 130 in that it can search the clinical and demographic information, and read and copy SIDS, PHIDS, and PIDS of information portions satisfying the search criteria. Note that the administrator processor 131 cannot determine patient identities since it has no privilege to access the first information storage facility 120.

According to the invention, and with reference still to FIGS. 1-4, a third party may, with a subscription, have privilege to access clinical and demographic information by way of third party processing 240 to clinical and demographic information of information in the second information structures in the second information storage facility 130 for the purpose of mining or searching that information. For example, the third party subscriber may use a clinical protocol model 239 to formulate and execute various queries against second facility clinical and demographic information by way of search path 240/150/139. The third party privilege is preferably limited to viewing only an aggregate number of second information structures which satisfy the search criteria, or it may extend to viewing or copying some portion of the clinical and demographic information, without viewing the PIDS, PHIDS, and SIDS.

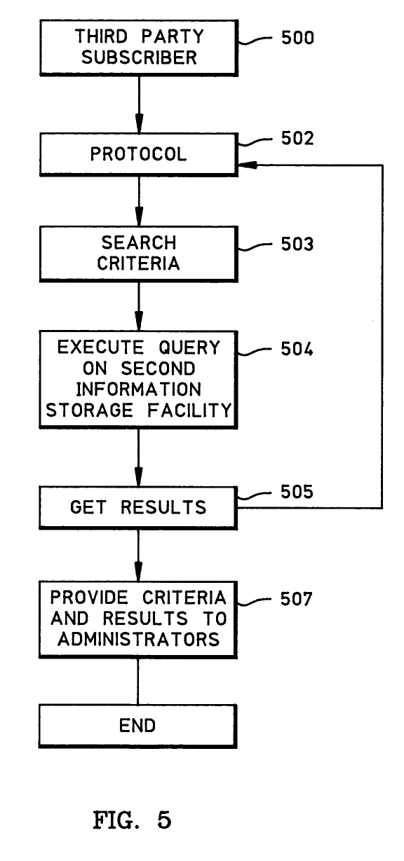

Referring to FIGS. 5, 6, and 7, the contents of the second information storage facility 130 may be mined or searched using mining or search criteria derived from the protocol model 239. The mining or search criteria may be used by one or more third party subscribers, subject to third party privileges described above. The mining or search criteria may also be used by the administrator 131, subject to administrator privileges described above. These figures represent processing steps undertaken by relevant technical means described above, which may include administrator, third party, source and physician processors. These figures also represent software instructions or routines in one or more programs of software instructions executed by one or more of such processors.

In FIG. 5, a third party subscriber 500 establishes a protocol in step 502 for a clinical trial, the protocol being used to provide mining/search criteria in step 503 for the second information storage facility 130. The criteria are included in a query executed in step 504 against the information contents of the second information storage facility 130. Search results are provided in step 505 and, if necessary, the protocol is adjusted in response to the query results. At least, the search results include the total number of second information portions satisfying the search results (these portions are also called “hits”). When satisfactory query results indicating an optimized protocol are obtained, the criteria and the results are provided to the administrator 131 in step 507. For example, the administrator may receive information that 30,000 hits were obtained in a search using stipulated search criteria for a stipulated protocol.

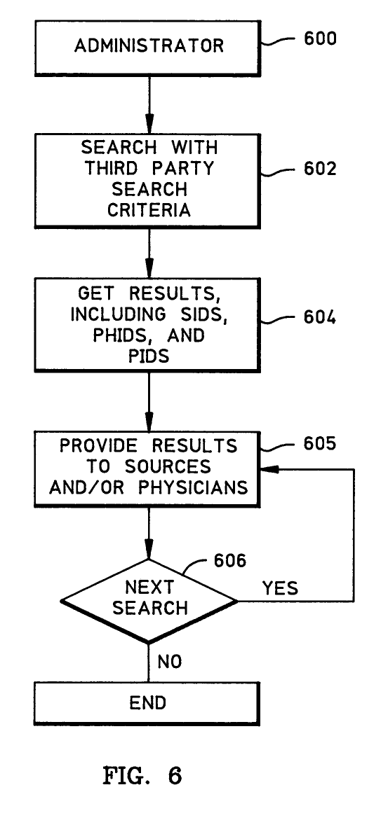

With reference to FIG. 6, the administrator 131 in step 600 receives query results and mining/search criteria from a third party subscriber and, in step 602 initiates a mine or search of information in the second information storage facility 130 using those criteria. Receiving results including SIDS, PHIDS, and PIDS in step 604, the administrator parses the results on a per-SID basis and/or a per-PHID basis in step 605. If a source identified by an SID receives results from the administrator processor 131, those results include, at most, the PHIDS associated with the source, the number of hits per PHID, and a summary of the protocol. The source, via technical means including a source processor, then contacts each identified physician associated with it, via technical means including an associated physician processor, of the protocol and the number of that physician's patients whose clinical and demographic information indicate that they are potential candidates for a clinical trial conducted according to the protocol. The contacted physicians return to the administrator processor 131 for the PIDS of their patients whose clinical and demographic information satisfies the criteria. Alternatively, the administrator processor 131 can provide the PIDS and protocol information directly to the identified physicians via technical means including associated physician processors

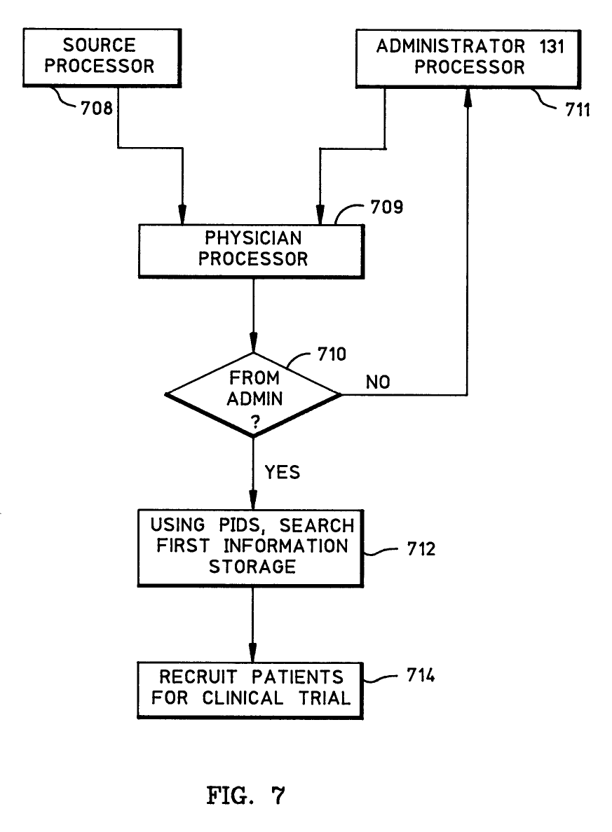

In FIG. 7, each physician identified in a search run by the administrator process according to FIG. 6 may receive notification from a source in step 708 with which the physician is associated or information via technical means described above. Preferably the notification includes a protocol description and a number of hits for that physician's patients counted for a query based on the protocol. In step 709, the physician processor considers information received from a source processor and takes the negative exit from step 710 upon determining that the administrator processor 131 is not the source. The information is enriched with the PIDS for the physician's hits by the loop 711, 709, 710 by which the physician processor obtains the PIDS from the administrator processor 131. Alternatively, the administrator processor 131 may deliver the PIDS and protocol information directly to the physician processor without intermediation by a source processor. Armed now with knowledge of a protocol and PIDS of its patients who potentially meet the criteria for the protocol, the physician, in step 712, accesses the first information storage facility 120 to obtain a list of patient identities. This is accomplished by use of the PIDS to search and retrieve first information portions containing those PIDS, which also contain the identity information for the patients. The list of patients thus obtained contains potential candidates for a clinical trial conducted according to a protocol used in an initial search of the second information storage facility 130. Now, using automated means including, for example patients' email addresses, the physician may recruit candidates for the trial from the list This is represented by step 714.

Another embodiment of the business method illustrated in FIGS. 5-7 contemplates the delivery of mining/search criteria with results of a search from a third party subscriber, subject to a privilege level which still denies the subscriber with access to PIDs, directly to one or more sources or physicians. Also within the scope of the invention is simply having a third party, with or without subscription, provide a search profile derived from desired clinical and demographic information for a protocol to the administrator 131 or to one or more sources, or to physicians without a third party search of the second information storage facility.

1. A computer-implemented method for processing patient medical information for storage, comprising:
separating the patient medical information into a first information portion that includes at least information identifying a patient and information identifying a physician of the patient, and a second information portion that includes clinical and demographic information for the patient, and the information identifying the physician, but that does not include information identifying the patient;
generating a unique code for the patient which does not identify the patient;
placing the unique code into the first and second information portion;
providing the first information portion for storage in a first storage; and
providing the second information portion for storage in a second storage, separate from the first storage.

2. The method of claim 1, wherein the first storage is a first database system and the second storage is a second database system, separate from the first database system, the method further comprising:
placing the first information portion in one or more first database records;
placing the second information portion in one or more second database records;
and wherein, providing the first information portion includes providing the one or more first database records for storage in the first database system, and providing the second information portion includes providing the one or more second database records for storage in the second database system.

3. The method of claim 1, wherein the clinical and demographic information includes at least one ICD (International Classification of Diseases) code.

4. The method of claim 1, wherein the clinical and demographic information includes genetic information.

5. The method of claim 1, further comprising:
providing at least one third party subscription to contents of the second storage;
permitting a third party holding a third party subscription to search the second storage using clinical trial search criteria;
obtaining search results including a count of second information portions in the third party search which satisfy the clinical trial search criteria; and
providing the clinical trial search criteria and the search results to an administrator process.

6. The method of claim 5, further comprising the administrator process searching the second storage using the clinical trial search criteria, obtaining search results including one or more unique codes and information identifying one or more physicians of patients for whom the one or more unique codes were generated.

7. The method of claim 6, further comprising:
associating a physician process with a physician; and
providing the one or more unique codes of the search results to the physician process;
the physician process:
obtaining from the first storage information identifying patients for whom the one or more unique codes of the search results were generated; and
using the information identifying patients for whom the one or more unique codes of the search results were generated, recruiting patients for a clinical trial.

8. An entry processor for processing patient medical information for storage, comprising:
means for separating the patient medical information into a first information portion that includes at least information identifying a patient and information identifying a physician of the patient, and a second information portion that includes clinical and demographic information for the patient, and the information identifying the physician, but that does not include information identifying the patient;
means for placing a unique code for the patient which does not identify the patient into the first and second information portion; and
means for providing the first information portion for storage in a first storage, and for providing the second information portion for storage in a second storage, separate from the first storage.

9. The entry processor of claim 8, in combination with means for generating the unique code.

10. The entry processor of claim 8, wherein the clinical and demographic information includes at least one ICD (International Classification of Diseases) code.

11. The entry processor of claim 8, wherein the clinical and demographic information includes genetic information of the patient.

12. The entry processor of claim 8 further including:
means for placing the first information portion in one or more first database records; and
means for placing the second information portion in one or more second database records;
and wherein, the means for providing includes means for providing the one or more first database records for storage in a first database system, and for providing the one or more second database records for storage in a second database system, separate from the first database system.

13. A processor associated with a physician for retrieving patient medical information from storage, the patient medical information having been separated into first records stored in a first database and second records stored in a second database, separate from the first database, each first record being for a respective patient of the physician and associated with a second record for the same patient by a unique code which is contained in the first and second records and which does not identify the patient, each first record including at least patient identification information identifying a patient and information identifying the physician, each second record including clinical and demographic information for a patient, and information identifying a physician of the patient, but not including information identifying a patient, the physician processor comprising:
means for receiving results of a search conducted on the second database according to clinical trial search criteria, the results including one or more unique codes for patients of the physician;
means for using the one or more unique codes to obtain patient identification information from the first database; and
means for recruiting one or more patients identified by the patient identification information obtained from the first database.

14. The processor of claim 13, wherein the clinical and demographic information includes at least one ICD (International Classification of Diseases) code.

15. The processor of claim 13, wherein the clinical and demographic information includes genetic information of the patient.

16. A processor combination for processing patient medical information for storage and retrieval, comprising:
at least one entry processor with:
means for separating patient medical information into a first information portion that includes at least information identifying a patient and information identifying the patient's physician, and a second information portion that includes clinical and demographic information for the patient, and the information identifying the patient's physician (PHID), but that does not include information identifying the patient;
means for placing a unique code (PID) which does not identify the patient into the first and second information portion; and
means for providing the first information portion for storage in a first storage, and for providing the second information portion for storage in a second storage, separate from the first storage; and
at least one additional processor, with:
means for searching the second data storage using clinical trial search criteria;
means for receiving search results from the second data storage in response to the clinical trial search criteria.

17. The combination of claim 16, wherein the at least one additional processor is an administrator processor associated with the second storage, and the search results include:
PIDS for patients whose clinical and demographic information satisfies the clinical trial criteria; and
PHIDS for physicians of the patients whose clinical and demographic information satisfies the clinical trial criteria.

18. The combination of claim 16, wherein the at least one additional processor is a third party subscriber processor, and the search results include a number of second information portions satisfying the clinical trial search criteria.

19. A business method for evaluating a clinical trial protocol using patient medical information and one or more processors, comprising:
receiving patient medical information;
the patient medical information including patient identification information and clinical and demographic information;
storing the patient identification information separately from the clinical and demographic information;
subjecting the stored patient identification information and the stored clinical and demographic information to anonymity constraints;
according at least one subscriber a privilege level with respect to the clinical and demographic information denying identification of patients associated with the clinical and demographic information;
permitting the subscriber to search the clinical and demographic information according to search criteria for a clinical trial protocol; and
providing results to the subscriber.

20. The business method of claim 19, wherein the anonymity constraints include:
providing a unique code for a patient which does not include identification of the patient;
appending the unique code for the patient to the patient identification information for that patient and to the clinical and demographic information for the patient; and
storing including storing the patient identification information with appended unique code in a first storage, and storing the clinical and demographic information with appended unique code in a second storage separate from the first storage.

21. The business method of claim 20, wherein the search results provided to the subscriber include a number of hits but do not include unique codes.

22. The business method of claim 20 further including:
according an administrator of the second storage a privilege level with respect to the clinical and demographic information denying identification of patients associated with the clinical and demographic information, but permitting retrieval of unique codes;
permitting the administrator to search the clinical and demographic information according to the search criteria for a clinical trial protocol; and
providing results to the administrator which include unique codes.
